(19) United States
(12) Patent Application Publication
(10) Pub. No.: US 2024/0157480 A1
(43) Pub. Date: May 16, 2024

(54) METHOD FOR PROCESSING A CARDBOARD WITH A LASER BEAM

(71) Applicant: BOBST MEX SA, Mex (CH)

(72) Inventors: Paul PIRON, Crissier (CH); Roberto VALTERIO, Ollon (CH)

(73) Assignee: BOBST MEX SA, Mex (CH)

(21) Appl. No.: 18/550,373

(22) PCT Filed: Mar. 8, 2022
(86) PCT No.: PCT/EP2022/055799

§ 371 Date: Sep. 13, 2023

(30) Foreign Application Priority Data
Mar. 17, 2021 (EP) 21163051.2

(51) Int. Cl. B23K 26/364; B23K 26/06; B23K 26/082; B23K 103/00

(52) U.S. Cl. CPC B23K 26/364; B23K 26/0648; B23K 26/082; B23K 2103/40

(57) ABSTRACT

A method for processing a cardboard (12) with a laser beam (14) is provided, wherein the laser beam (14) is moved over the cardboard (12) along a desired folding line (24) such that an upper layer of the cardboard (12) is ablated without cutting through the cardboard (12), wherein the laser beam (14) is adjusted such that the laser beam (14) is focused below the cardboard (12). Further, a device (10) for carrying out a method for processing a cardboard (12) with a laser beam (14) is provided.

The invention refers to a method for processing a cardboard with a laser beam and a device for carrying out a method for processing a cardboard with a laser beam.

In order to enable easy folding of a cardboard along a desired folding line, cardboards are usually creased along the folding line. The creasing may be accomplished by mechanical creasing or by means of a laser, wherein the laser ablates an upper layer of the cardboard along the folding line.

However, when using a laser, a plurality of creasing lines is necessary in order to enable a sufficient folding. For example, to enable a folding about 90°, at least three creasing lines are necessary. For enabling a folding about 180°, at least five creasing lines are necessary. Thus, creasing the cardboard with a laser is rather time consuming.

US 2013/0296150 A1 describes a laser beam scanner for applying a pre-treatment of a cardboard, for example creasing the cardboard, wherein the creases may operate to ease folding of the cardboard. CN 112203796 A discloses an apparatus and a method for processing cardboard using laser irradiation. In particular a surface of a cardboard blank is irradiated with a laser in order to remove material from the cardboard blank. EP 2 700 583 A1 discloses a cardboard with folding lines 14 which are produced by impinging the cardboard with a laser beam. All these documents of the state-of-the art disclose a laser beam setup which is identical to the ones used for cutting, i.e., a focused laser setup. Thus, they suffer from the above-mentioned disadvantages if applied to creasing cardboard.

It is thus an object of the present invention to increase productivity in the processing cardboards.

According to the invention, this object is achieved by a method for processing a cardboard with a laser beam, wherein the laser beam is moved over the cardboard along a desired folding line such that an upper layer of the cardboard is ablated without cutting through the cardboard, wherein the laser beam is adjusted such that the laser beam is not focused on the cardboard.

The object of the invention is further achieved by a device for carrying out a method for processing a cardboard with a laser beam as previously described, wherein the device has a laser beam source, a deflection device being configured to deflect the laser beam such that it can be moved over the cardboard along a desired folding line, and a focusing lens which is configured to adjust the focus of the laser beam such that the laser beam is not focused on the cardboard.

The inventive method and device have the advantage that the laser impinges on the cardboard with a larger diameter than a laser that is focused directly on an upper layer of the cardboard. Thereby, the part ablated from the cardboard is wider compared to the use of a laser focused on the cardboard. Consequently, less motion lines of the laser are necessary to remove the necessary width of the cardboard. For example, only two creasing lines are necessary for folding the cardboard about 180° compared to five creasing lines when processing the cardboard according to the conventional method. Having fewer creasing lines reduces the risk of accidentally overlapping lines, which would cause the laser beam to cut through the cardboard.

Preferably, material is ablated only on the inner side of the cardboard such that the creasing lines are not visible from the outside of a folded cardboard (i.e not visible on the final packaging).

For example, the laser beam impinges on the cardboard with a diameter of at least 0.3 mm and in particular up to 2 mm. Preferably, the unfocused laser impinges on the cardboard with a diameter between 0.5 mm and 2 mm, in particular 1.1 mm. Thereby, the laser beam is still strong enough to ablate a part of the cardboard and a sufficiently large amount of the upper surface of the cardboard is removed by the laser beam.

The laser beam may be moved along the cardboard in a continuous line, a dashed line and/or a dot-dashed line. Moving the laser beam along the cardboard in a dashed line or a dot-dashed line has the advantage, that less material is ablated along the folding line and the risk that the cardboard might get ruptured along the folding line is decreased.

According to one embodiment, the laser beam is moved along the desired folding line in two parallel lines. Thereby, enough material can be ablated to enable folding the cardboard about at least 90°, in particular 180°.

Preferably, the parallel lines do not overlap. Thereby, it is avoided that laser beam cuts through the cardboard. In particular, there may be a slight distance between the parallel lines in order to take into account production tolerances.

According to a further embodiment, the laser beam is moved along the folding line in a plurality of parallel lines that are inclined to the folding line. Thereby, a particularly wide folding line may be achieved without having to move the laser beam back and forth along the folding line. According to this embodiment, the width of the folding line depends on the length of the parallel lines.

The laser beam may be moved along the cardboard by means of at least one galvanometer scanner. By means of a galvanometer scanner, the laser beam can be moved with a particularly high accuracy.

According to one embodiment, the laser beam is focused by means of a focusing lens, in particular a converging lens. By using a focusing lens, the focus of the laser beam may be adjusted particularly easy.

Before entering the focusing lens, the laser beam may be diverged. Thereby, it is possible that the laser beam has a bigger diameter when impinging on the cardboard than when exiting a laser beam source.

Further features and advantages can be derived from the following description and the enclosed figures. In the figures:

FIG. 1 shows a device according to the invention for carrying out an inventive method for processing a cardboard with a laser beam,

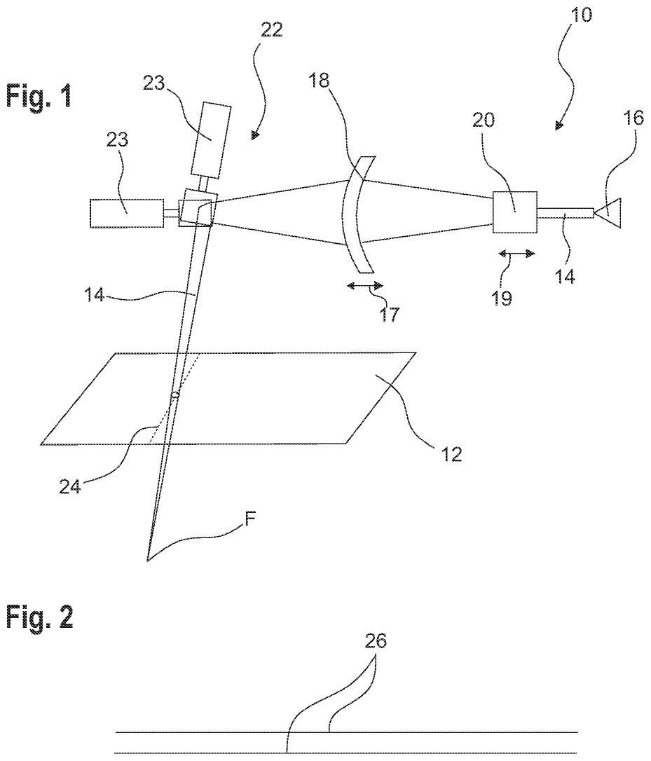

FIG. 2 shows a laser beam path according to a first embodiment,

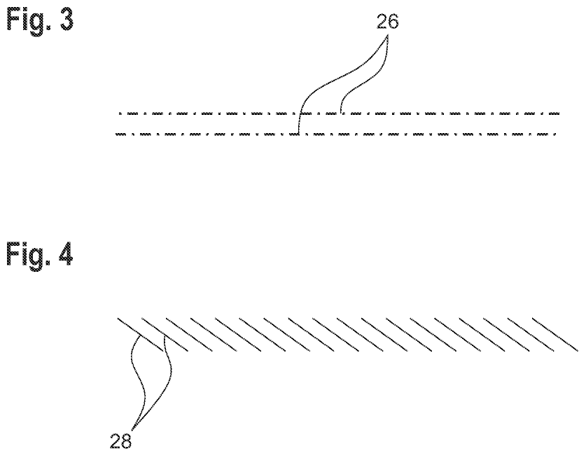

FIG. 3 shows a laser beam path according to a further embodiment, and

FIG. 4 shows a laser beam path according to a further embodiment.

FIG. 1 shows a device 10 for processing a cardboard 12 with a laser beam 14.

The device 10 has a laser beam source 16, from which a laser beam 14 emerges.

Moreover, the device 10 comprises a focusing lens 18. The position of the focusing lens 18 may be adjustable as indicated by arrow 17 in FIG. 1.

The device 10 further optionally has a diverging lens 20 through which the laser beam 14 passes after emerging from the laser beam source 16. The position of the diverging lens 20 may as well be adjustable, as indicated by arrow 19.

After passing the diverging lens 20 and the focusing lens 18, the laser beam 14 impinges onto a deflection device 22.

The deflection device 22 is configured to deflect the laser beam 14 such that it can be moved over the cardboard 12 along a desired folding line 24, which is visualized in FIG. 1 by a dashed line.

For this purpose, the deflection device 22 comprises a least one galvanometer scanner 23. In particular, the deflection device 22 according to the embodiment shown in FIG. 1 comprises two galvanometer scanners 23. Thereby, the laser beam 14 can be moved over the surface of the cardboard 12 in all directions.

By means of the focusing lens 18 the focus F of the laser beam 14 is adjusted such that the laser beam 14 is focused below or above the cardboard 12 (preferably below the cardboard 12).

Thus, the laser beam 14 impinges on the cardboard 12 with a diameter of at least 0.3 mm. In particular, the diameter of the laser beam 14 may be up to 2 mm when it impinges on the cardboard 12.

While moving over the cardboard 12, the diameter with which the laser beam 14 impinges on the cardboard 12 might slightly vary. However, this is not disadvantageous.

When the laser beam 14 is moved along the cardboard 12, the upper surface of the cardboard 12 is ablated by the laser beam 14. Yet, the laser beam 14 does not completely cut through the cardboard 12. Consequently, the cardboard 12 can be easily folded afterwards.

FIG. 2 visualizes a laser beam path according to one embodiment. According to this embodiment, the laser beam 14 is moved over the cardboard 12 along two parallel lines 26. The parallel lines 26 extend along the folding line 24. Thereby, the cardboard 12 may be folded around the folding line 24 about at least 90°, in particular about up to 180°.

In the embodiment according to FIG. 2, the lines 26 are continuous.

FIG. 3 visualizes a different laser pattern. According to the embodiment visualized in FIG. 3, the lines 26 are not continuous, but dot-dashed.

The dots and dashes of the two lines 26 may be displaced with respect to each other in an axial direction.

In a further embodiment, which is not visualized in the Figures, the lines 26 may be only dashed or dotted.

FIG. 4 visualizes a further laser pattern. According to FIG. 4, the laser beam 14 is moved along the folding line 24 in a plurality of parallel lines 28 that are inclined to the folding line 24. For example, the lines 28 are inclined to the folding line 24 for about 30° to 50°.

1. A method for processing cardboard with a laser beam, the method comprising:
moving the laser beam is over the cardboard along a desired folding line such that an upper layer of the cardboard is ablated without cutting through the cardboard; and
adjusting the laser beam such that the laser beam is focused below or above the cardboard.

2. The method according to claim 1, wherein the laser beam impinges on the cardboard with a diameter of at least 0.3 mm and in particular up to 2 mm.

3. The method according to claim 1, wherein the laser beam is moved along the cardboard in a continuous line, a dashed line, and/or a dot-dashed line.

4. The method according to claim 1, wherein the laser beam is moved along the desired folding line in two parallel lines.

5. The method according to claim 4, wherein the two parallel lines do not overlap.

6. The method according to claim 1, wherein the laser beam is moved along the folding line in a plurality of parallel lines that are inclined to the folding line.

7. The method according to claim 1, wherein the laser beam is moved along the cardboard by at least one galvanometer scanner.

8. The method according to claim 1, wherein the laser beam is focused by focusing lens.

9. The method according to claim 8, wherein the laser beam is diverged before entering the focusing lens.
